(19) United States
(12) Patent Application Publication
(10) Pub. No.: US 2004/0096215 A1
(43) Pub. Date: May 20, 2004

(54) Method and apparatus for performing system monitoring in a terminal independent interface located between a terrestrial optical terminal and an undersea optical transmission path

(76) Inventors: Stephen G. Evangelides JR., Red Bank, NJ (US); Jay P. Morreale, Summit, NJ (US); Michael J. Neubelt, Little Silver, NJ (US); Mark K. Young, Monmouth Junction, NJ (US); Jonathan A. Nagel, Brooklyn, NY (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/621,115

(22) Filed: Jul. 16, 2003

Related U.S. Application Data
(60) Provisional application No. 60/404,615, filed on Aug. 20, 2002.
(60) Provisional application No. 60/404,608, filed on Aug. 20, 2002.

(51) Int. Cl. H04B 10/08

(52) U.S. Cl. 398/33

(57) ABSTRACT

An optical transmission system has an optical transmission terminal with first and second optical interfaces. The first interface is configured to communicate in accordance with an industry-standard, network level protocol. The second interface is configured to communicate in accordance with a first optical layer transport protocol. The optical transmission span includes an optical interface device that has a third interface communicating with the second interface of the optical transmission terminal in accordance with the first optical layer transport protocol and a fourth interface configured to communicate in accordance with a second optical layer transport protocol. The optical interface device also includes a signal processing unit for transforming optical signals between the first and second optical layer protocols. A test system is coupled to the signal processing unit for monitoring optical signal quality. The optical transmission span also includes an optical transmission path optically coupled to the fourth optical interface of the optical interface device for transmitting optical signals in accordance with the second optical layer protocol.

This application claims the benefit of priority of U.S. Provisional Patent Application No. 60/404,615, filed Aug. 20, 2002, entitled “Terminal Independent Interface.”

This application also claims the benefit of priority of U.S. Provisional Patent Application No. 60/404,608, filed Aug. 20, 2002, entitled “Idler Channel Generator.”

This application is also related to co-pending U.S. patent application Ser. No. ______ [Docket No. 9005/9] filed on even date herewith, entitled “Method And Apparatus For Providing A Terminal Independent Interface Between A Terrestrial Optical Terminal And An Undersea Optical Transmission Path.”

This application is also related to co-pending U.S. patent application Ser. No. ______ [Docket No. 9005/10] filed on Jul. 3, 2003, entitled “Method And Apparatus For Using Optical Idler Tones For Performance Monitoring In A WDM Optical Transmission System.”

### FIELD OF THE INVENTION

The present invention relates generally to optical transmission systems, and more particularly to an optical interface for providing communication between a terrestrial optical terminal and an undersea optical transmission path.

### BACKGROUND OF THE INVENTION

Terrestrial optical transmission networks serving as high-speed backbone networks have for some time now employed the SONET/SDH standards, which is an interface that was established for interconnecting optical transmission equipment from different suppliers. As shown in FIG. 3, optical terminals supplied by various vendors can communicate with one another using customer interfaces that conform to SONET/SDH. Such terminals generally also include a proprietary interface that allows a given vendor to interconnect their own optical terminals without the limitations imposed by SONET/SDH. The proprietary interface communicates over an optical layer transport protocol that is proprietary to the vendor and which depends on parameters such as system length and capacity.

One type of highly specialized optical transmission network are undersea or submarine optical transmission systems in which a cable containing optical fibers is installed on the ocean floor. The design of such optical transmission systems is generally customized on a system-by-system basis and employ highly specialized terminals to transmit data over the undersea optical transmission path. Since the specialized terminals are produced in small volumes they are relatively expensive in comparison to the optical terminals that are designed to communicate over terrestrial optical layer protocols, which are typically produced in relatively high volume for terrestrial optical transmission networks.

The terrestrial terminals are generally not employed over undersea transmission paths because of various limitations imposed by the terrestrial optical layer transport protocols. These limitations include the relatively short spans or links that terrestrial optical layer protocols support, optimization for TDM traffic rather than WDM traffic, a network management scheme that assumes there is readily available access to the equipment along the transmission path, a lack of functions to effectively manage traffic other than traditional voice traffic based on TDM technology, an inefficient use of bandwidth to provide protection circuitry, as well as other inherent limitations in managing and supporting high bandwidth optical networks.

Accordingly, while it would clearly be desirable to use readily available terrestrial optical terminals in undersea transmission systems to reduce costs, terrestrial optical terminals generally do not provide the optical layer functionality required by undersea transmission systems.

### SUMMARY OF THE INVENTION

In accordance with the present invention, an optical transmission span is provided, which is incorporated in an optical transmission system. The optical transmission system has an optical transmission terminal with first and second optical interfaces. The first interface is configured to communicate in accordance with an industry-standard, network level protocol. The second interface is configured to communicate in accordance with a first optical layer transport protocol. The optical transmission span includes an optical interface device that has a third interface communicating with the second interface of the optical transmission terminal in accordance with the first optical layer transport protocol and a fourth interface configured to communicate in accordance with a second optical layer transport protocol. The optical interface device also includes a signal processing unit for transforming optical signals between the first and second optical layer protocols. A test system is coupled to the signal processing unit for monitoring optical signal quality. The optical transmission span also includes an optical transmission path optically coupled to the fourth optical interface of the optical interface device for transmitting optical signals in accordance with the second optical layer protocol.

In accordance with one aspect of the invention, the third and fourth interfaces are bi-directional interfaces.

In accordance with another aspect of the invention, the industry-standard, network level protocol is SONET/SDH.

In accordance with another aspect of the invention, the industry-standard, network level protocol is ATM.

In accordance with another aspect of the invention, the industry-standard, network level protocol is Gigabit Ethernet.

In accordance with another aspect of the invention, the second optical layer transport protocol includes wavelength division multiplexing.

In accordance with another aspect of the invention, the second optical layer transport protocol supports at least one signal process selected from the group consisting of gain equalization, bulk dispersion compensation, optical gain, Raman amplification, dispersion slope compensation, PMD compensation, and performance monitoring.

In accordance with another aspect of the invention, the optical transmission path is an undersea optical transmission path.

In accordance with another aspect of the invention, the test system includes a test signal generator generating an optical test signal, an optical coupler combining the test signal with at least one data signal located at a given channel wavelength, and an optical performance monitor receiving at least a portion of the optical test signal.

In accordance with another aspect of the invention, at least one optical amplifier is located in the optical transmission path. The optical test signal is located at one or more channel wavelengths distinct from the given channel wavelength and corresponds to an idler channel wavelength employed to maintain a prescribed operation state of the optical amplifier

In accordance with another aspect of the invention, the optical transmission span further includes at least one optical amplifier located in the optical transmission path. At least one optical loopback path is associated with the optical amplifier. The optical loopback path optically couples a first unidirectional optical transmission path to a second unidirectional optical transmission path. The optical performance monitor receives a portion of the optical test signal conveyed over the optical loopback path.

In accordance with another aspect of the invention, the test signal generator includes a tone generator generating a tone having a pseudo-random sequence and an optical transmitter coupled to the tone generator for generating an optical test signal based on the pseudo-random tone.

In accordance with another aspect of the invention, the optical performance monitor includes a signal performance monitor for selectively monitoring the one or more channel wavelengths of the test signal and the data signal.

In accordance with another aspect of the invention, a method is provided for transmitting an optical signal. The method begins by receiving an optical data signal in accordance with a first optical layer protocol from an optical transmission terminal having first and second optical interfaces. The first interface is configured to communicate in accordance with an industry-standard, network level protocol. The second interface is configured to communicate in accordance with the first optical layer protocol. The optical data signal is transformed so that it is in conformance with a second optical layer protocol. The transformed optical data signal is directed through an optical transmission path in accordance with the second optical layer protocol. An optical test signal is generated and directed onto the optical transmission path. Finally, a performance characteristic of the optical test signal is monitored.

In accordance with another aspect of the invention, the optical test signal is generated by generating a tone having a pseudo-random sequence and then generating the optical test signal based on the pseudo-random tone.

In accordance with another aspect of the invention, the performance characteristic is selected from the group consisting of a Q-value, a bit error rate, and an optical-signal-to-noise ratio.

### BRIEF DESCRIPTION OF THE DRAWINGS

FIG. 1 shows the various layers of the OSI network hierarchy and its correspondence to SONET/SDH.

FIG. 2 shows the layers of a SONET/SDH over optical layer network.

FIG. 3 shows a conventional link in a SONET/SDH network as typically employed in terrestrial optical networks.

FIG. 4 shows a block diagram of the network architecture constructed in accordance with the present invention.

FIG. 5 shows a block diagram of one embodiment of the inventive optical interface device depicted in FIG. 4.

FIG. 6 shows one embodiment of the inventive optical line interface that employs a performance monitor.

FIG. 7 shows an example of a test signal generator that may be employed in the performance monitor shown in FIG. 6.

### DETAILED DESCRIPTION

The present inventors have recognized that specialized undersea optical terminals are often not required for undersea transmission systems. Rather, less expensive, readily available terrestrial optical terminals can be used by providing an appropriate interface between the terrestrial terminals and the undersea transmission path. The interface provides high compatibility between the proprietary interface of terrestrial optical terminals available from multiple vendors and the undersea transmission path. That is, the interface is designed to be terminal independent and serves as an interface between terrestrial optical layer transport protocols and an undersea optical layer transport protocol. Examples of terrestrial optical terminals that are currently available and which may be used in connection with the present invention include, but are not limited to, the Nortel LH1600 and LH4000, Siemens MTS 2, Cisco 15808 and the Ciena CoreStream long-haul transport products.

To facilitate a better understanding of the present invention, an overview of network protocols will be presented below. Additional details may be found, for example, in Chapter 6 of Optical Networks: A Practical Perspective, R. Ramaswami and K. Sivarajan, Academic Press, 1998, which is hereby incorporated by reference in its entirety.

### Network Protocols

Networks almost universally employ multiple layers of protocols. A low-level physical layer protocol assures the transmission and reception of a data stream between two devices. Data packets are constructed in a data link layer. Over the physical layer, a network and transport layer protocol governs transmission of data through the network, thereby ensuring end-to end reliable data delivery.

As computer and transmission networks have developed, various approaches have been used in the choice of communication medium, network topology, message format, protocols for channel access, and so forth. Some of these approaches have emerged as de facto standards, but there is still no single standard for network communication. However, a model for network architectures has been proposed and widely accepted. It is known as the International Standards Organization (ISO) Open Systems Interconnection (OSI) reference model. The OSI reference model is not itself a network architecture. Rather it specifies a hierarchy of protocol layers and defines the function of each layer in the network. Each layer in one node of the network carries on a conversation with the corresponding layer in another node with which communication is taking place, in accordance with a protocol defining the rules of this communication. In reality, information is transferred down from layer to layer in one node, then through the channel medium and back up the successive layers of the other node. However, for purposes of design of the various layers and understanding their functions, it is easier to consider each of the layers as communicating with its counterpart at the same level, in a “horizontal” direction.

The lowest layer defined by the OSI model is called the physical layer, and is concerned with transmitting raw data bits over the communication channel. Design of the physical layer involves issues of electrical, mechanical or optical engineering, depending on the medium used for the communication channel. The layer next to the physical layer is called the data link layer. The main task of the data link layer is to transform the physical layer, which interfaces directly with the channel medium, into a communication link that appears error-free to the next layer above, known as the network layer. The data link layer performs such functions as structuring data into packets or frames, and attaching control information to the packets or frames, such as checksums for error detection, and packet numbers. The network layer performs the end-to-end routing function of taking a message at its source and delivering it to its destination. Above the network layer are the transport, session, presentation, and application layers.

### SONET/SDH and Optical Layer Protocols

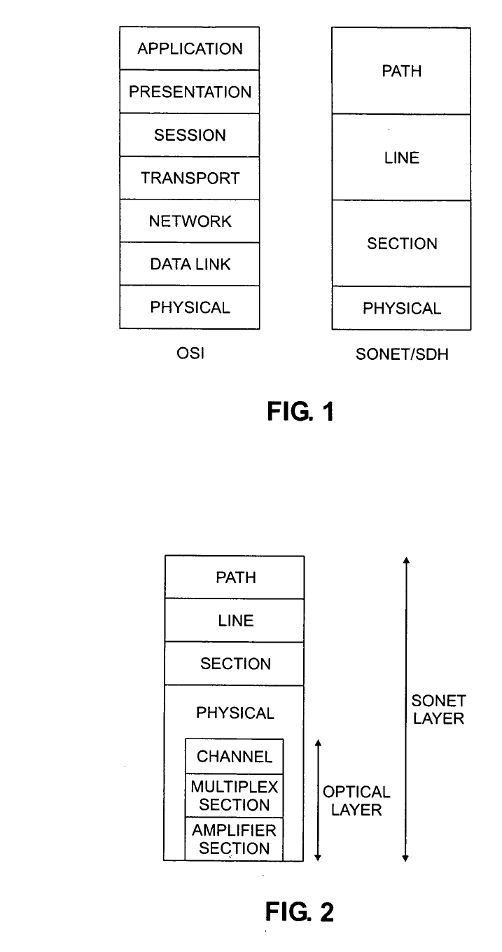

The SONET/SDH standards provide an interface to a network level protocol that consists of four layers. These layers are combinations and derivatives of the seven-layer OSI model. A rough correspondence between the seven layers of the OSI model and SONET/SDH is shown in FIG. 1. The path layer is responsible for monitoring and tracking end-to-end connections between nodes. The line layer multiplexes a number of path layer connections onto a single link between two nodes. Each link is divided into a number of sections, which correspond to link segments between regenerators. The physical layer is responsible for the actual transmission of bits across the fiber.

The International Telecommunications Union (ITU) has recently defined a new layer, the optical layer, which corresponds to the physical layer in the OSI model. The breakdown of the optical layer into its various sublayers is described in ITU recommendation G.681. As shown in FIG. 2, the optical layer in turn consists of three sublayers, the optical channel layer, the optical multiplex section and the optical amplifier section. The optical layer is responsible for end-to-end routing of a lightpath (i.e., an-end to-end connection using a single wavelength on each link). The optical multiplex section layer is used to represent a point-to-point link along the route of a lightpath. The optical amplifier section layer controls the links between optical amplifiers.

In a realistic network, two or more of the above-mentioned protocol stacks may reside one on top of the other. For example, a SONET/SDH over optical layer network is shown in FIG. 2. In this case the SONET/SDH network treats the optical layer network as its physical layer. That is, the physical layer of SONET/SDH is replaced with the optical layer.

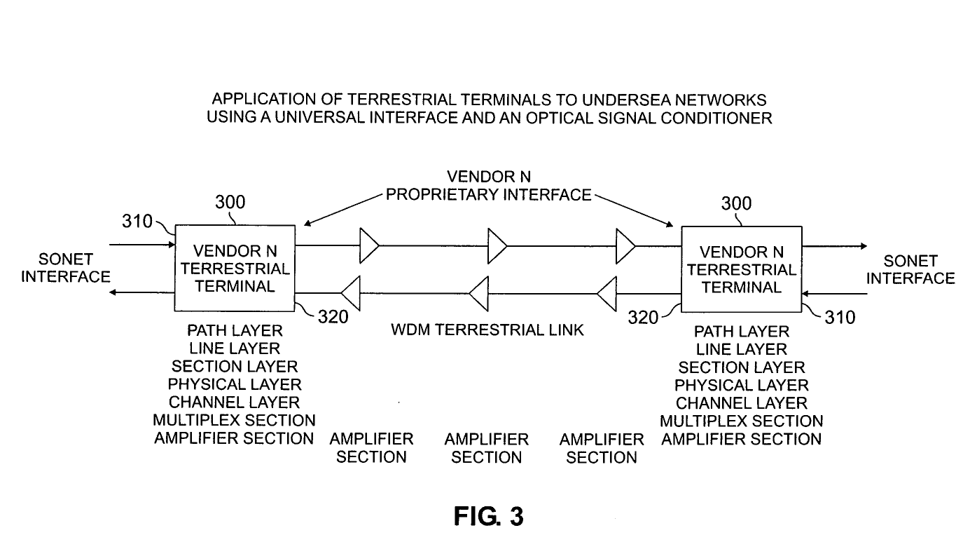

FIG. 3 shows a conventional link in a SONET/SDH network as typically employed in terrestrial optical networks. The link consists of two SONET/SDH terminals 300 that are provided by a single vendor. The terminals have SONET/SDH interfaces 310 that allow them to interconnect with customer equipment and transmission equipment from different suppliers. The terminals also include a proprietary interface 320 that allows a given vendor to interconnect their own optical terminals without the limitations imposed by SONET/SDH. The proprietary interface communicates over an optical layer transport protocol that is proprietary to the vendor. Directly below the terminals 300 in FIG. 3 are shown the layers employed by the terminal interfaces. The SONET/SDH interface 310 is shown in terms of the SONET/SDH over optical layer network seen in FIG. 2.

### Optical Interface

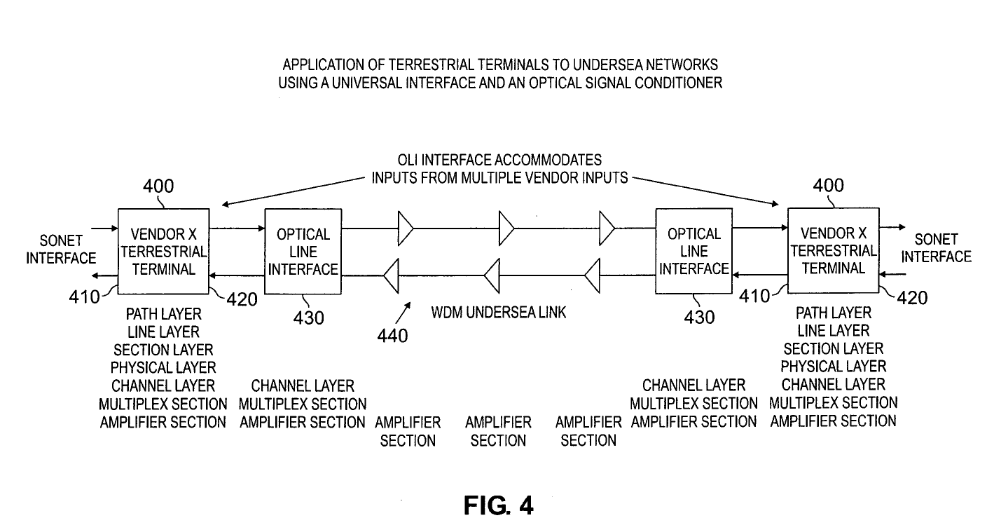

The present inventors have recognized that an undersea communication system may replace the specialized terminals that are typically employed with less expensive, commercially available, SONET/SDH terminals. This can be accomplished by replacing, on the proprietary interface side, the physical layer of the SONET/SDH terminals with an optical layer transport protocol that is more appropriate for undersea systems. The SONET/SDH terminals are equipped with an interface such as an adaptor card that allows it to communicate with the optical layer transport protocol employed in the undersea communication path. FIG. 4 shows a block diagram of the inventive network architecture.

In FIG. 4 the proprietary, optical layer interfaces 420 of the SONET/SDH terminals 400 communicate over an undersea optical transmission path 440 that provides optical layer functionality. An optical interface device 430 provides the connectivity between the SONET/SDH terminals 400 and the undersea optical transmission path 440. That is, the undersea optical transmission path 440 is transparent to the SONET/SDH terminals 400 so that from their perspective they are communicating over their own proprietary links.

The optical interface device 430 receives the optical signals from the optical layer interface 420 of the SONET/SDH terminals 400. The interface device 430 provides the optical layer signal conditioning that is not provided by the SONET/SDH terminals 400, but which is necessary to transmit the optical signals over the undersea transmission path 440. The signal conditioning that is provided may include, but is not limited to, gain equalization, bulk dispersion compensation, optical gain, Raman amplification, dispersion slope compensation, polarization mode dispersion (PMD) compensation, performance monitoring, dummy channel insertion, or any combination thereof. The aforementioned signal conditioning processes generally reside in the optical amplifier section of the optical layer transport protocol shown in FIG. 2. More generally, however, the present invention encompasses an optical interface device that provides signal conditioning at any one or more of the optical sublayers depicted in FIG. 2.

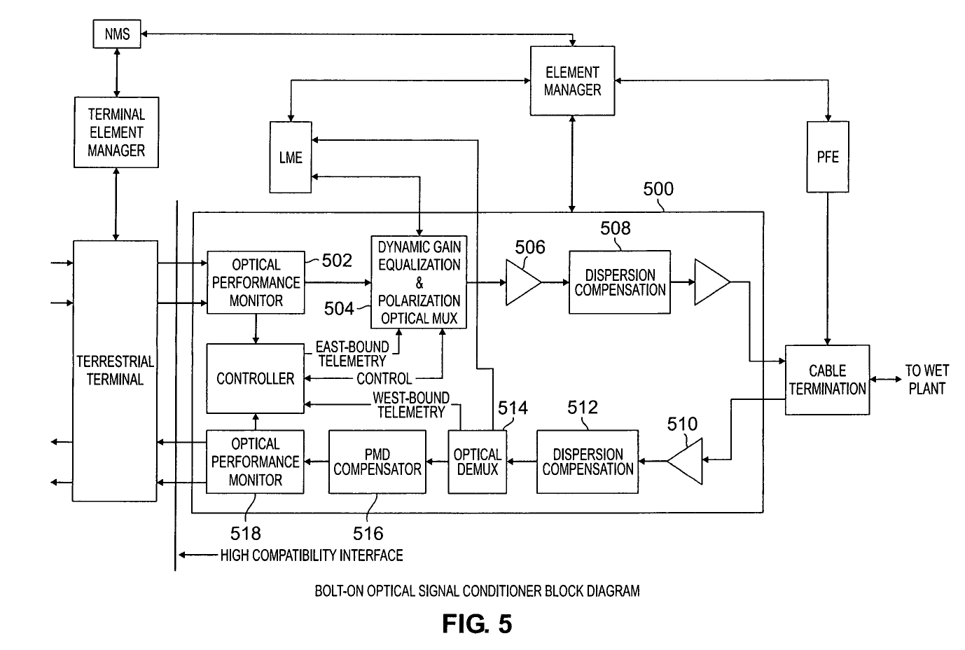

FIG. 5 shows a block diagram of one embodiment of the inventive optical interface device 500 depicted in FIG. 4. The optical signal received from the SONET/SDH terminal is monitored for optical performance by optical performance monitor 502, then power equalized by polarization multiplexer 504, optically amplified by amplifier 506, and passed through a dispersion compensation device 508 such as a dispersion compensating fiber or a grating-based dispersion compensation device, after which the optical signal is ready to traverse the undersea optical transmission path. Likewise, the optical signal received by the interface device 500 from the undersea optical transmission path is optically amplified by amplifier 510, passed through a dispersion compensation device 512, optically demultiplexed by demultiplexer 514, passed through a polarization mode dispersion (PMD) compensator 516, and monitored for performance by optical performance monitor 518.

The optical performance monitors 502 and 518 ensure that appropriate signal quality is maintained. The optical performance monitors 502 and 518 may measure the OSNR, Q-factor, or BER of the optical signal. In operation, a tap or other device directs a small portion of the optical signal to an optical amplifier, filter, and a receiver for converting the optical signal to an electrical signal. A dual channel CDR with an adjustable decision threshold and phase is used to determine the error performance of the data signal. The optical performance information determined by the performance monitor 520 may be used as feedback to control the gain equalizer 504 or the PMD compensator 516.

### Performance Monitoring

The optical performance monitors 502 and 518 ensure that appropriate signal quality is maintained. The optical performance monitors 502 and 518 may measure the OSNR, Q-factor, or BER of the optical signal. In operation, a tap or other device directs a small portion of the optical signal to an optical amplifier, filter, and a receiver for converting the optical signal to an electrical signal. A dual channel CDR with an adjustable decision threshold and phase is used to determine the error performance of the data signal. The optical performance information determined by the performance monitor 520 may be used as feedback to control the gain equalizer 504 or the PMD compensator 516.

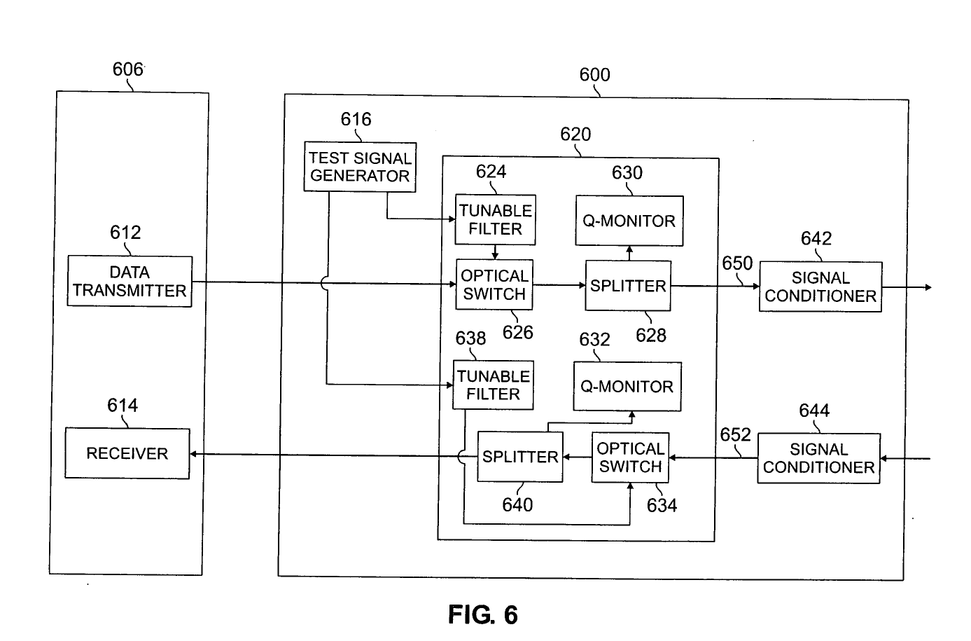

Because the inventive optical interface device preferably operates at the optical layer level, the device generally does not have access to the data payload in the optical signals and thus cannot use such data to monitor signal quality. FIG. 6 shows one embodiment of the inventive optical line interface 600 that employs a performance monitor suitable for determining signal quality without the need for accessing the data payload. The optical line interface 600 is shown connected to a terrestrial terminal 606 that includes a transmitting unit 612 for generating data-carrying channels that are to be transmitted over optical fiber 650 and a receiving unit 614 for receiving data-carrying channels that are received over optical fiber 652. For simplicity, the various components of the optical line interface 600 that process the signals at the optical level are represented by signal conditioners 642 and 644. The signal conditioners 642 and 644 may include the various components depicted in FIG. 5, which perform optical layer functionality such as gain equalization, bulk dispersion compensation, optical gain, Raman amplification, dispersion slope compensation, PMD compensation, and performance monitoring.

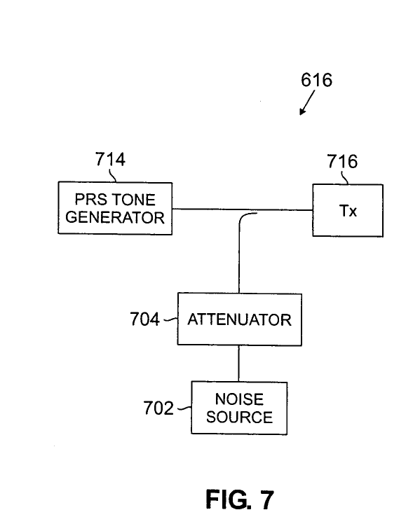

A performance monitor 620 is used to monitor the performance of both the outgoing and incoming data-carrying signals. A test signal generator 616 generates the pseudo-random optical test signal at one or more of the idler channel wavelengths. One example of the test signal generator 616 is shown in FIG. 7. Test signal generator 716 includes pseudo-random sequence (PRS) tone generator 714 connected to laser transmitter 716 for generating and outputting a pseudo-random sequence of tones. In some embodiments of the invention laser transmitter 716 generates a pseudo-random optical tone that has an OSNR that can be pre-established. For example, the OSNR can be established by adding selected amounts of optical noise to the optical tone by optical noise source 702 and optical attenuator 704. As described in greater detail below, the pseudo-random optical tone is used as a test tone to monitor the health of the WDM transmission system.

Turning first to the transmitting side of the performance monitor 620, the optical test signal from the test signal generator 616 is received by a tunable filter 624 that selects the particular test channel or channels that are to be used for performance monitoring. An optical switch 626 is used to select the data-carrying signal from the data transmitter 612 and one or more test channels from the tunable filter 624. A splitter 628 directs a portion of the signal received from the optical switch 626 to a Q-monitor 630. The Q-monitor 630 in turn can monitor the quality of the data-carrying signals received from the data transmitting unit 612. The Q-monitor 630 can also monitor the test channels to verify the operation of the Q-monitor 630 itself. If a problem arises with a particular channel in the data-carrying signal as indicated by a low Q-value, the Q-value of the test channel can then be measured. By comparing the Q-value for both the test channel and the data channel in which there is a problem at both the local and remote terminals, the problem with the data channel can be localized. In addition, if the transmission system in which OLI 600 is used employs loop-back paths, the Q-monitor 630 can also be used to monitor the test signals traversing optical fiber 652 during system deployment.

On the receiving side of the performance monitor 620, Q-monitor 632 can be used in a manner similar to monitor 630 to monitor system performance. In particular, the test signals generated by test signal generator 616 can be directed to the Q-monitor 632 via tunable filter 638, optical switch 634, and splitter 640. The Q-monitor 632 can also monitor the data-carrying signals received along fiber 652 as well as the test signals traversing optical fiber 650 during system deployment if loop-back paths are employed.

In some embodiments of the invention, the test channels correspond to unused or idler channels that may be employed in the transmission system. Idler channels are used to maintain gain flatness and gain tilt of the amplifiers when the system is operating at less than the maximum number of channels it can support. For example, WDM systems are often initially deployed at less than their maximum capacity. That is, a system designed to transmit 30 or more channels, for instance, initially may be more lightly loaded with only 2, 4, or 8 channels. The idler channels are often provided as unmodulated or cw tones. As the WDM system is upgraded, idler channels can be removed and replaced with data-carrying channels. Given that idler tones are often present before a WDM system is operating at its full capacity with a complete complement of channels, the idler channels can also serve as test channels.

Although various embodiments are specifically illustrated and described herein, it will be appreciated that modifications and variations of the present invention are covered by the above teachings and are within the purview of the appended claims without departing from the spirit and intended scope of the invention. For example, while the present invention has been described in terms of an interface for terrestrial optical terminals that conform to SONET/SDH standards, the present invention is equally applicable to an interface for terrestrial optical terminals that conform to other industry standard protocols such as ATM and Gigabit Ethernet, for example.

1. In an optical transmission system having an optical transmission terminal with first and second optical interfaces, said first interface being configured to communicate in accordance with an industry-standard, network level protocol, said second interface being configured to communicate in accordance with a first optical layer protocol, an optical transmission span comprising:
an optical interface device that includes:
a third interface communicating with the second interface of the optical transmission terminal in accordance with the first optical layer protocol;
a fourth interface configured to communicate in accordance with a second optical layer protocol; and
a signal processing unit for transforming optical signals between the first and second optical layer protocols;
a test system coupled to the signal processing unit for monitoring optical signal quality;
an optical transmission path optically coupled to the fourth optical interface of the optical interface device for transmitting optical signals in accordance with said second optical layer protocol.

2. In the optical transmission system of claim 1, an optical transmission span wherein said third and fourth interfaces are bi-directional interfaces.

3. In the optical transmission system of claim 1, an optical transmission span wherein said industry-standard, network level protocol is SONET/SDH.

4. In the optical transmission system of claim 1, an optical transmission span wherein said industry-standard, network level protocol is ATM.

5. In the optical transmission system of claim 1, an optical transmission span wherein said industry-standard, network level protocol is Gigabit Ethernet.

6. In the optical transmission system of claim 1, an optical transmission span wherein said second optical layer protocol includes wavelength division multiplexing.

7. In the optical transmission system of claim 1, an optical transmission span wherein said second optical layer protocol supports at least one signal process selected from the group consisting of gain equalization, bulk dispersion compensation, optical gain, Raman amplification, dispersion slope compensation, PMD compensation, and performance monitoring.

8. In the optical transmission system of claim 6, an optical transmission span wherein said second optical layer protocol supports at least one signal process selected from the group consisting of gain equalization, bulk dispersion compensation, optical gain, Raman amplification, dispersion slope compensation, PMD compensation, and performance monitoring.

9. In the optical transmission system of claim 1, an optical transmission span wherein said optical transmission path is an undersea optical transmission path.

10. In the optical transmission system of claim 9, an optical transmission span wherein said second optical layer protocol is configured for said undersea optical transmission path.

11. In the optical transmission system of claim 1, an optical transmission span
wherein said signal processing unit performs at least one process on the optical signals selected from the group consisting of gain equalization, bulk dispersion compensation, optical gain, Raman amplification, dispersion slope compensation, PMD compensation, and performance monitoring.

12. In the optical transmission system of claim 1, an optical transmission span wherein said test system comprises:
a test signal generator generating an optical test signal;
an optical coupler combining the test signal with at least one data signal located at a given channel wavelength; and
an optical performance monitor receiving at least a portion of the optical test signal.

13. In the optical transmission system of claim 12, an optical transmission span further comprising at least one optical amplifier located in said optical transmission path, said optical test signal being located at one or more channel wavelengths distinct from the given channel wavelength and corresponding to an idler channel wavelength employed to maintain a prescribed operation state of said at least one optical amplifier

14. In the optical transmission system of claim 12, an optical transmission span further comprising:
at least one optical amplifier located in said optical transmission path;
at least one optical loopback path associated with said at least one optical amplifier, said at least one optical loopback path optically coupling a first unidirectional optical transmission path to a second unidirectional optical transmission path and wherein said optical performance monitor receives a portion of the optical test signal conveyed over said at least one optical loopback path.

15. In the optical transmission system of claim 12, an optical transmission span wherein said test signal generator comprises:
a tone generator generating a tone having a pseudo-random sequence; and
an optical transmitter coupled to the tone generator and generating an optical test signal based on the pseudo-random tone;

16. In the optical transmission system of claim 12, an optical transmission span wherein said optical performance monitor includes a signal performance monitor for selectively monitoring said one or more channel wavelengths of the test signal and said at least one data signal.

17. In the optical transmission system of claim 16, an optical transmission span wherein said signal performance monitor is a Q-monitor.

18. A method of transmitting an optical signal, said method comprising the steps of:
receiving an optical data signal in accordance with a first optical layer protocol from an optical transmission terminal having first and second optical interfaces, said first interface being configured to communicate in accordance with an industry-standard, network level protocol, said second interface being configured to communicate in accordance with the first optical layer protocol;
transforming the optical data signal so that it is in conformance with a second optical layer protocol; and
directing the transformed optical data signal through an optical transmission path in accordance with the second optical layer protocol;
generating an optical test signal;
directing said optical test signal onto the optical transmission path; and
monitoring a performance characteristic of said optical test signal.

19. The method of claim 18 wherein said optical transmission path is a bi-directional transmission path.

20. The method of claim 18 wherein said industry-standard, network level protocol is SONET/SDH.

21. The method of claim 18 wherein said industry-standard, network level protocol is ATM.

22. The method of claim 18 wherein said industry-standard, network level protocol is Gigabit Ethernet.

23. The method of clam 18 wherein said second optical layer protocol includes wavelength division multiplexing.

24. The method of claim 18 wherein said second optical layer protocol supports at least one signal process selected from the group consisting of gain equalization, bulk dispersion compensation, optical gain, Raman amplification, dispersion slope compensation, PMD compensation, and performance monitoring.

25. The method of claim 24 wherein said second optical layer protocol supports at least one signal process selected from the group consisting of gain equalization, bulk dispersion compensation, optical gain, Raman amplification, dispersion slope compensation, PMD compensation, and performance monitoring.

26. The method of claim 18 wherein said optical transmission path is an undersea optical transmission path.

27. The method of claim 26 wherein said second optical layer protocol is configured for said undersea optical transmission path.

28. The method of claim 18 wherein said signal processing unit performs at least one process on the optical data signals selected from the group consisting of gain equalization, bulk dispersion compensation, optical gain, Raman amplification, dispersion slope compensation, PMD compensation, and performance monitoring.

29. The method of claim 18 wherein said optical transmission path includes at least one optical amplifier, said optical test signal being located at one or more channel wavelengths corresponding to an idler channel wavelength employed to maintain a prescribed operation state of said at least one optical amplifier.

30. The method of claim 18 wherein said monitoring step comprises the step of receiving a portion of the optical test signal that has traversed at least one optical loopback path optically coupling a first unidirectional optical transmission path to a second unidirectional optical transmission path.

31. The method of claim 18 wherein the step of generating said optical test signal further comprising the steps of:
generating a tone having a pseudo-random sequence; and
generating said optical test signal based on the pseudo-random tone.

32. The method of claim 31 wherein said performance characteristic is a Q-value.

33. The method of claim 31 wherein said performance characteristic is selected from the group consisting of a Q-value, a bit error rate, and an optical-signal-to-noise ratio.

34. The method of claim 18 further comprising the step of monitoring a performance characteristic of said at least one optical data signal.

35. An optical interface device for use in an optical transmission system having an optical transmission terminal with first and second optical interfaces, said first interface being configured to communicate in accordance with an industry-standard, network level protocol, said second interface being configured to communicate in accordance with a first optical layer protocol, said optical interface device comprising:
a third interface communicating with the second interface of the optical transmission terminal in accordance with the first optical layer protocol;
a fourth interface configured to communicate in accordance with a second optical layer protocol; and
a signal processing unit for transforming optical signals between the first and second optical layer protocols;
a test system coupled to the signal processing unit for monitoring optical signal quality;
an optical transmission path optically coupled to the fourth optical interface of the optical interface device for transmitting optical signals in accordance with said second optical layer protocol.

36. The optical interface device of claim 35 wherein said third and fourth interfaces are bi-directional interfaces.

37. The optical interface device of claim 35 wherein said industry-standard, network level protocol is SONET/SDH.

38. The optical interface device of claim 35 wherein said industry-standard, network level protocol is ATM.

39. The optical interface device of claim 35 wherein said industry-standard, network level protocol is Gigabit Ethernet.

40. The optical interface device of claim 35 wherein said second optical layer protocol includes wavelength division multiplexing.

41. The optical interface device of claim 35 wherein said second optical layer protocol supports at least one signal process selected from the group consisting of gain equalization, bulk dispersion compensation, optical gain, Raman amplification, dispersion slope compensation, PMD compensation, and performance monitoring.

42. The optical interface device of claim 40 wherein said second optical layer protocol supports at least one signal process selected from the group consisting of gain equalization, bulk dispersion compensation, optical gain, Raman amplification, dispersion slope compensation, PMD compensation, and performance monitoring.

43. The optical interface device of claim 35 wherein said optical transmission path is an undersea optical transmission path.

44. The optical interface device of claim 43 wherein said second optical layer protocol is configured for said undersea optical transmission path.

45. The optical interface device of claim 35 wherein said signal processing unit performs at least one process on the optical signals selected from the group consisting of gain equalization, bulk dispersion compensation, optical gain, Raman amplification, dispersion slope compensation, PMD compensation, and performance monitoring.

46. The optical interface device of claim 35 wherein said test system comprises:
a test signal generator generating an optical test signal;
an optical coupler combining the test signal with at least one data signal located at a given channel wavelength; and
an optical performance monitor receiving at least a portion of the optical test signal.

47. The optical interface device of claim 46 further comprising at least one optical amplifier located in said optical transmission path, said optical test signal being located at one or more channel wavelengths distinct from the given channel wavelength and corresponding to an idler channel wavelength employed to maintain a prescribed operation state of said at least one optical amplifier

48. The optical interface device of claim 47 further comprising:
at least one optical amplifier located in said optical transmission path;
at least one optical loopback path associated with said at least one optical amplifier, said at least one optical loopback path optically coupling a first unidirectional optical transmission path to a second unidirectional optical transmission path and wherein said optical performance monitor receives a portion of the optical test signal conveyed over said at least one optical loopback path.

49. The optical interface device of claim 46 wherein said test signal generator comprises:
a tone generator generating a tone having a pseudo-random sequence; and
an optical transmitter coupled to the tone generator and generating an optical test signal based on the pseudo-random tone;

50. The optical interface device of claim 35, an optical transmission span wherein said optical performance monitor includes a signal performance monitor for selectively monitoring said one or more channel wavelengths of the test signal and said at least one data signal.

51. The optical interface device of claim 50, an optical transmission span wherein said signal performance monitor is a Q-monitor.
